(19) United States
(12) Patent Application Publication
(10) Pub. No.: US 2006/0107314 A1
(43) Pub. Date: May 18, 2006

(54) Content management system and method

(76) Inventor: John Michael Cataldi, Sugar Hill, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/273,458

(22) Filed: Nov. 14, 2005

Related U.S. Application Data
(60) Provisional application No. 60/627,417, filed on Nov. 12, 2004.
(60) Provisional application No. 60/627,416, filed on Nov. 12, 2004.

(51) Int. Cl. G06F 15/16

(52) U.S. Cl. 726/15

(57) ABSTRACT

A modular site design system, method, and application service provider platform that creates, deploys, and publishes an electronic presence. The system employs a graphical user interface (GUI), also known as a wizard that allows a portal owner to create, deploy, and publish their electronic presence quickly to interactive devices. The GUI includes modules and filters, located on the application service provider (ASP) platform, which portal owners can utilize to alter their end user's experience. The modules are typically owned by the ASP. When a portal owner completes their selection and customization of electronic modules, the ASP platform generates a package, including the modules, database schemes, and other information used as the blueprint to create the electronic presence stored on the ASP. Once deployed the portal owners end users can access the products, service offerings, and personalized workflow that was originally conceived from the portal owners selections on the ASP platform.

Priority based on U.S. Provisional Patent Application Ser. No. 60/627,417, filed Nov. 12, 2004, and entitled “Agency Content Management Personalization Wizard”, and U.S. Provisional Patent Application Ser. No. 60/627,416, filed Nov. 12, 2004, and entitled “Prepaid Dating Card”, is claimed.

### BACKGROUND

I. Field of the Invention

The present invention relates generally to the field of network based content management, and more particularly to a content management system and method.

II. Description of the Related Art

For marketing and general commerce purposes many clients are looking for turnkey business opportunities on the internet and mobile devices. With the advent of the graphic user interface a client can create their own turnkey business presence with little technical knowledge utilizing pre-packaged business modules that are highly customizable to target the right product/service to the correct demographic over not only the internet, but on a multitude of electronic platforms. The present invention is generally related to remote content management and electronic deployment through a graphical user interface.

Developing electronic real estate can be a costly proposition. The development of the business model, the individual product offering, languages, billing applications, hosting, hardware, scalability, multiple electronic deployments (internet, mobile, etc.) and technical expertise can all be road blockers to ones success. Through the utilization of a GUI, our client can create, edit, and deploy a unique electronic agency/storefront in a matter of minutes. Moreover, the GUI controls the sites attributes giving our client's end user's a distinct experience. Unlike, stand alone applications, the GUI, associated content, product/service modules, and functional (behavioral) engines are all contained on an application. This allows the clients offering always to be updated and maintained on a singular network insuring client scalability and uptime.

The prior art product/service deployment systems have several disadvantages. Most importantly, a returning webmaster may not receive credit for a past sale if the cookie is blocked or deleted by the end user, which is now common place for anti-virus scans and as a default preset for current Microsoft Windows operating systems. Secondly, the proliferation of such an affiliate system over of a large network of related websites would amplify the prior issue of customer tracking and personalization to the end user. Common place in the webmaster community of today is the use of landing pages. These are one page websites that act as a doorway to the merchant's site that is hosted by the affiliate/client that links to the merchant using a tracking URL and/or cookies. For large website networks, it is common place to utilize a singular affiliate program across an entire network. This is referred to as “Affiliate Pooling” U.S. Pat. No. 6,804,660 by Landau et al. discloses such an affiliate network. A webmaster operates a web site. Next, a request for a target Merchant Web site triggers a correlation function, such that the source Webmaster unique identifier is correlated to a target Webmaster unique identifier functional within the unique identification system of the requested Merchant system. Next, a properly formatted entry mechanism URL is returned, enabling a hand off to the target Merchant affiliate system and including the correlated target Webmaster unique identifier. The Virtual Affiliate system is notified of transactions that originated from a referring Webmaster. Referring Webmasters may be compensated for each completed transaction according to agreed-upon terms and conditions. A serious disadvantage of the Landau system is the tracking mechanism employed will be lost on the end users direct return to the referred website if the cookie is lost or deleted. Secondly, the “target Webmaster” which is the merchant site, acts as a stand alone site that is the same for all affiliates. This seriously limits webmaster/affiliates ability to create a personalized experience for their end users. Lastly, there is a limitation on platform distribution, in which the only end user access to the affiliate is through the internet, whereas mobile, PDA, and other interactive devices have been omitted.

### SUMMARY

A design and deployment architecture is provided that apportions certain aspects of creating, maintaining, and publishing electronic content into discrete components. The discrete components may include, for example, product/service modules, functional modules, graphic user interface, navigation trees, etc. The components are provided through a flexible client interface at the application service provider or host that permits a client to pick and choose which components are to be presented in the finished product/service portal. When a client completes component selection, the group of components are packaged together and forwarded to the application service provider platform. At the application service provider platform, the components are assembled and linked to the client to provide the desired electronic presence. With such an arrangement, a client can pick and choose the desired site features and functionality at minimal cost. Moreover, the client can publish over multiple channels to include the internet, mobile devices, PDA, etc.

In addition, the architecture facilitates the upgrade of modules, graphic interfaces or web site features. The digital assets reside not on the clients services but on the application service provider platform which maintains the infrastructure, core applications, and hosting of the client. By providing the ability to add version numbers to one or more electronic site components, the client can roll out new applications easily and rapidly. As the versions are upgraded at Application Service Provider platform, the modules will be upgraded as they are released to the client's electronic presence. Because client content is hosted on the ASP platform, not merely linked to the web site components, seamless upgrades of the site may be achieved without undesirably affecting the productivity of the clients' business.

According to one aspect of the invention, a site design tool includes a plurality of product/service modules, design modules, an interface enabling selection, by a user, of different ones of the design modules of the plurality to be included in a site, the selected design modules forming a package of design modules; and means for forwarding the package of design modules to the ASP Platform will create, update, or add functionality to a clients electronic presence.

According to another aspect of the invention, the end product of the client's use of the design tool allows the emulation of the content into various structures to be displayed across a multitude of channels. The end result, the client can publish over multiple channels to include the internet, mobile devices, PDA, etc.

According to a further aspect of the invention, a host server includes a memory storing a plurality of portal pages associated with a electronic presence, the computer comprising a directory structure, identifying locations of modules that are used to provide functional and visual attributes for the web pages, content for display on the site; and means for dynamically linking the content to site.

According to a further aspect of the invention, client tracking to the application service provider/core merchant platform is done through a unique gateway identifier that is either owned by the client or assigned by the application service provider that is host specific, non-cookie based.

According to another aspect of the invention, in a modular web design system wherein web sites are comprised of a plurality of hosted modules, a method for updating one of the modules including the steps of forwarding an updated version of one of the modules to a client using the one of the modules; storing, at the Application Service Provider/Host, the updated version of the one of the modules; replacing, in a directory structure at the client, a first pointer to an existing version of the one of the modules with a second point to the updated version of the one of the modules.

With such an arrangement, a system is provided which is modular nature, has the ability to identify upgraded versions of modules, with the ability to spawn a site at a user location. In addition, the separation of user content from functional and design modules provide the ability to make enable upgrades to a large number or network of sites in an automated fashion.

In general, the invention further features electronic site creation, development, content management and electronic deployment through a graphical user interface (GUI).

In general, in one aspect, the invention features a method of providing a website on a network so that a users seeking common interests can access one another on the network, the method including creating on the network a web portal, granting web portal access to the users on the network, providing to the users access to a components database connected to the network, providing to the users a shared database connected to the network, the shared database based on criteria subsets chosen from the components database and providing a medium connected to the network through which a subset of users that match the criteria subsets can access so that the subset of users who share common interests can interact via the medium.

In one implementation, the web portal is created using a pre-selected templates database.

In another implementation, the web portal is created using proprietary templates.

In another implementation, the web portal is developed using a modular site design system.

In another implementation, the modular site design system includes a plurality of design modules, an interface for selecting a subset of design modules of the plurality of design modules to be included in an electronic presence, the selected design modules forming a package of design modules and means for forwarding the package of design modules to an application service provider platform and deployment onto an electronic medium.

In another implementation, the method further includes selecting design criteria and forwarding the design criteria which resides on an application service provider platform for electronic publishing.

In another implementation, selecting design criteria includes selecting a design module for the web portal, selecting database inclusions for the web portal, selecting database filters for the web portal and optionally selected inclusions of various product service offerings from a plurality of design modules at a graphic user interface.

In still another implementation, the web portal in one of a superset of modular web portals, thereby forming an electronic presence.

In yet another implementation, the modular web portals are linked.

In another implementation, the method further includes optionally updating one of the web portals.

In another implementation, updating one of the web portals includes forwarding an updated version of one of the modules to an application service provider using the one of the modules, storing, at the application service provider, the updated version of the one of the modules, replacing, in a directory structure at the application service provider, a first pointer to an existing version of the one of the modules with a second pointer to the updated version of the one of the modules.

In another aspect, the invention features a network-based method, including providing a member database having data related to individual users, the users being members of a plurality of network websites, providing a component database having a pre-selected data components, providing access to a member to the to choose a subset of the pre-selected data components to form a filter that selects a subset of data related to individual users from the first database, and forming a second database being populated with the subset of data that has been selected based on the subset of pre-selected data components of the component database.

In one implementation, the method further includes providing on-line communication access between members who share common interests identified by common selections of the component database.

In another implementation, the communication access is a chatroom.

In another aspect, the invention features a method of network-based development of virtual communities, comprising accessing a network portal through a membership that provides access to the portal, the membership related to an interest, using a graphical user interface having a series of fields into which data can be entered, the data relating to specific criteria subsets related to the interest, submitting the data to the network, that data being used to generate a filter, receiving return data to the graphical user interface from a shared database, wherein data in the shared interface has been received through the filter from a membership database populated with users who share membership access to the network portal and using the return data to access a subset of users based on the filter criteria, thereby forming a virtual community of users who share common interests, the subset of users being formed from filtering a larger community of users in the membership database.

In one implementation, the method further includes providing an additional web portal connected to the network, the additional web portal providing access to the network and to the membership database, the additional web portal having fields that can be populated with criteria data to generate a filter that provides users of shared interests from the membership database.

In another implementation, the method further includes rendering payment for membership with a prepaid dating card.

One advantage of the invention is that users of the method and system can quickly generate an electronic presence that immediately attracts membership users.

Another advantage of the invention is that membership users can quickly and efficiently contact subsets of users who share common interests.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an embodiment of a network diagram provided to illustrate communication links between a Application Service Provider and a client seeking to use the site design system and method of the present invention; FIG. 2 illustrates an embodiment of a block diagram showing exemplary components that may be included at The Application Service Provider to provide site component package according to the present invention; FIG. 3 illustrates an embodiment of a flow diagram illustrating exemplary steps that may be performed at the Application Service Provider to generate the web site component package of FIG. 2;

FIG. 4 illustrates an embodiment of a block diagram illustrating exemplary components that display the output created by the application service provider; and

FIG. 5 illustrates an embodiment of a prepaid dating system for a user to purchase and activate prepaid dating cards.

### DETAILED DESCRIPTION

In general, the systems and methods described herein offer management of a network or online personal sites in various niche markets and provide portal solutions allowing other websites to manage online portals. Quick introduction of niche and specific portals are possible resulting in quick saturation of niche markets. Sites, whether dating, gaming or other paradigms work very similarly. A member enters their information and searches for a match based upon their personal preferences. Several media including video chat, member voice mail SMS, cell phone dating, traditional chat rooms and the like can be quickly implemented in any given portal/site development. A portal development wizard can be used to rapidly implement and customize a portal using an application service provider based model of saving customized values and serving the same values accordingly providing a unique user interface and experience.

As further discussed in the description below, the basic steps include: choosing a site template from a bank of templates available or custom creating and uploading template values; configuring style sheet values using an HTML editor or style sheet wizard; providing site related information as the tag line, site name and the like; submitting data filters segmenting demographic, lifestyle and activity based information; uploading site logo and add site text; adding metadata; and adding affiliate banners, text links and the like.

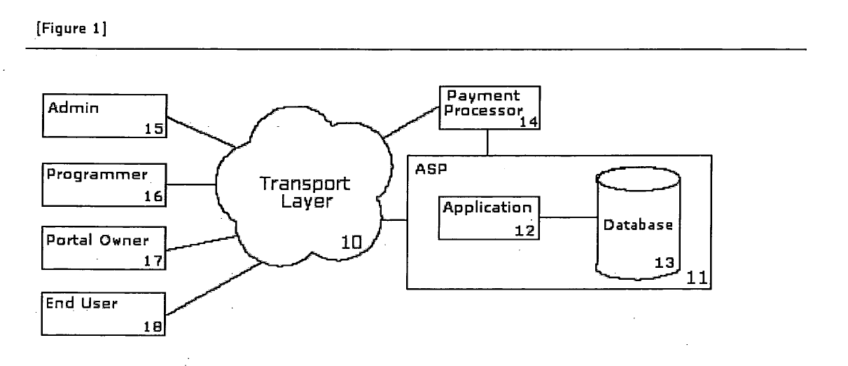

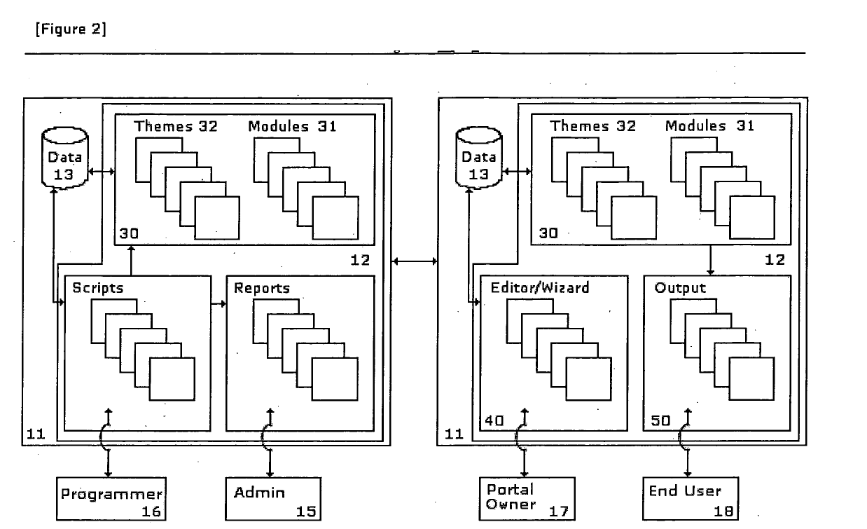

Referring to the drawings wherein like reference numerals designate corresponding parts throughout the several figures, reference is made first to FIG. 1 that illustrates an embodiment a network in which an embodiment of architecture can be used is shown to have an admin group 15, a programmers group 16, and a portal owner 17 is able to have a session with the application 12, through a transport layer 10. They are all able to use the application 12 and database 13. An end user 18 can have a session with the portal owners' application. Any transactions that take place are handled by a payment gateway 14.

Referring now to FIG. 2 that illustrates exemplary sets of components that can be included. A programmer group 16 is able to store a set of tools in the form of utilities or files on the Application to build or edit the modules stored for use. Each of the modules is comprised of program code that is generated by the programmer 16 that resides on the ASP 11 and is deployed to the application layer 12 when updates occur. Each of the modules The Admin group 15 is able to use a set of tools that enables them to view reports of the system. The portal owner group 17 is able to access a set of tools known as a wizard 40 that grants access to reports and will allow them to edit/create an application. The end user group 18 is able to view the output created by the application. As described above, the program code could be any code that is used to perform any function or represent a set of visual attributes, and the present invention is not limited to the provision of any particular code. In a typical implementation, the programmer group is able to make updates and patch an Application Service whenever necessary following a controlled versioning system.

When a portal owner interacts with the output builder 40 they first select the type of product/service they are building, in many cases this is site specific. For example, http://www.DateApp.com only creates dating sites, thus the product/service module is predetermined within the site builder application. Each product/service module 31 has an associated content server that connects the associated database with the product or service being offered. Through the GUI the client chooses the attributes associated with the product to include the functional modules 31 and skin modules 32. Dependant upon the product/service initially selected, various commission or product pricing levels may be selected. The administration module is generated based upon the site or sites created. The Portal Owners Output 50 is shown which includes modules that have been forwarded to the output upon the portal owners' selection.

Referring now to FIG. 3 that illustrates an embodiment of exemplary sets of components that can also be included. An example of how a portal owner can use the Wizard 40. The portal owner 17 can select a product/service module 41, for example it may be a dating portal. Next, they select colors and themes 42 for the application. In completion the portal owner browses add-ons in the form of modules 43. The portal owner can select modules and save their settings. When a Portal Owner returns to an application, the portal owner is able to login 44, view reports 45, and configure and edit 46 the application.

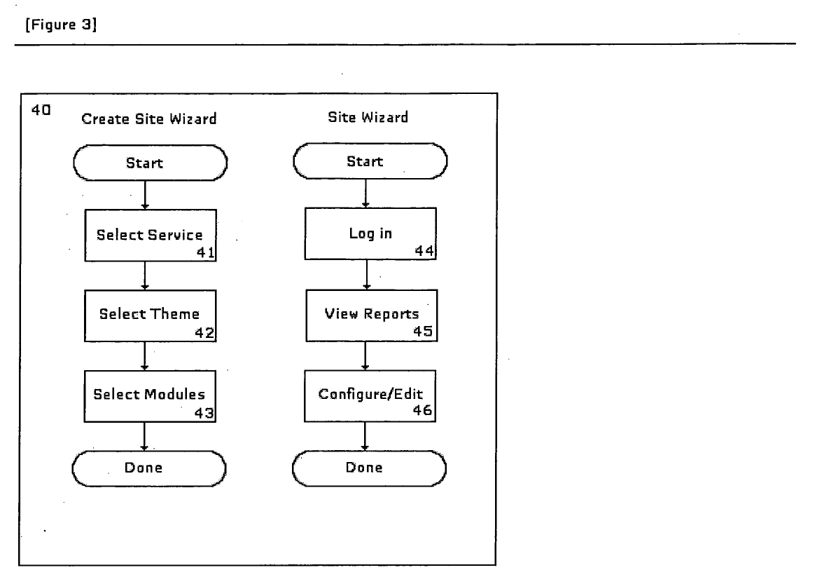

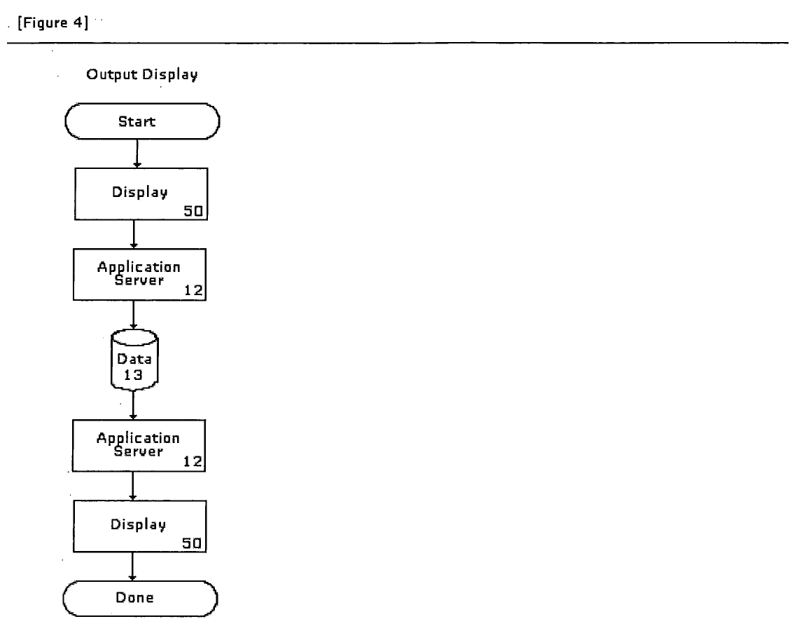

Referring to now to FIG. 4 that illustrates exemplary sets of components that may be included. Output is displayed 50 when an end user interacts with the application. The Application 12 makes a Read or Write request from the Database 13, and the new output will formatted by the Application Server 12 to be displayed 50 for the end user 18.

In an embodiment of the systems and methods described above, a modular site design system can be developed that generally includes a number of design modules, an interface enabling selection that is coupled to the design modules. In general, a user can use one or more subsets of the design modules of the number of design modules to be included in an electronic presence. The selected design modules generally form a package of design modules. The system can further include one or more devices or other means for forwarding the package of design modules to the application service provider platform and deployment onto an electronic medium.

In a typical implementation, the modular site design system typically includes a plurality of design modules that include visual modules and functional modules. Furthermore, the interface is a graphical user interface. In addition, the design modules typically include a parse tool to display various attributes of the database to the portal owners' end users. In addition, the design modules include administration modules for administering the Portal Owners electronic presence.

In general, the design modules can be used for a variety of purposes including but not limited to video on demand, video on demand, syndicated content, financial services, sports, social networking, advertising, gaming, lead generation, shopping, syndicated broadcasts, communications, community services, blogging, remote operation of a mechanical object, tracking, military use.

In general, the application service provider platform owns and operates a software application and typically operates and maintains the servers that run the application. In addition the application service provider platform makes the application available to the Portal Owners via an electronic platform, either in a browser or through some sort of “thin client”. In general, the application owns all the data gathered through its interaction with the portal owners end users.

In another embodiment, the systems described herein can include a method for designing and deployment of an electronic presence for a portal owner including the steps of selecting a design module, database inclusions, database filters, and/or inclusions of various product service offerings from a plurality of design modules at a graphic user interface and forwarding the design module which resides on Application Service Provider platform for electronic publishing.

In a typical implementation, the design module is a graphical user interface or alternatively, a functional module that affects design, product, service, workflow, and database properties.

In addition, the deployment of an electronic can include a variety of devices including, but not limited to a web browser, a mobile device, a PDA, an IPOD, PSP, a PS2, a cellular phone, a storage device, a mobile device, a prepaid device and a mechanical device. In general, it is appreciated that any computer, electrical or mechanical device can easily be implemented.

In general, in another implementation, the application service provider platform acts as a depository and retains all end user data of the portal owner. In addition, the database inclusions can be used to select a variety of components including but not limited to various product offerings, templates, cascading style sheets, template attributes, language attributes, member demographics, meta data, RSS feeds and deployment type.

In general, in another embodiment, a modular portal owner design system is contemplated wherein a resulting electronic presence includes a plurality of linked modules and a method for updating one of the modules including forwarding an updated version of one of the modules to an application service provider using the one of the modules, storing, at the application service provider, the updated version of the one of the modules, replacing, in a directory structure at the application service provider, a first pointer to an existing version of the one of the modules with a second point to the updated version of the one of the modules.

In a specific implementation, of the systems and methods described herein, multiple ‘dating’ portal websites can be developed, having access to a common database of members having access to the dating websites. The members may have chosen to be a member of one or more of the websites. However, in a typical implementation, they have become members of all of the websites. As such, each of the members has the potential to contact one another depending on the criteria that they have chosen in their particular website interface. In general, the members have seamless access to a components database. By choosing interface criteria, such as interests, sexual orientation race and the like, a filter is created from a subset of the pre-selected criteria of the components database. Therefore, as the filter is built, the member limits the types of members of the larger populated database to create a subset of the database in another shared interest database. By making this selection, the member has access to other members who have common criteria. Once this selection is created, the member can contact other members through, for example, chatrooms and be able to become more intimately knowledgeable of particular members of interest. From this point, the members can choose how they want to potentially meet each other or make other arrangements of communication.

Therefore, a single dating portal can be easily created. Several portals or websites can be created and managed across several networks containing different sets of members, but optionally all having access to the larger populated database. From a single domain, a webmaster can create a theme to match multiple websites and brandings, whether the site members are looking for love, a friend, a certain lifestyle, sexuality or geographic region. The portal can therefore provide a customized database to meet whatever the members' needs. Any given member can choose from fields in the interface that are interchangeable and have potentially infinite iterations. For example, the fields can be chosen from relationship type, activity, lifestyle and location, which equal a niche community. A more specific example of chosen fields can be friends, movies, straight, and New York, which results in a site for heterosexual movie-goers in New York. It is now appreciated that the fields are linked directly to the components database for use in creating the filters as described above. The use of customized, or shared, databases as described above provides a send of community and raises the webmaster's conversion rate, that is, paid memberships, and retention, that is, the time being a paid member.

In general, the features described above provide systems and methods that include content management capability. Due to the described flexibility of the development and the multiple networks available, the system provides ability to add content to individual sites as well as available content. In general, the sites can be modified in a large variety of ways, including but not limited to customizing a database to clientele to target a certain end user, custom templates, front page text, metadata/header, calendar ability, articles, links, and discussion boards. Site features can include but are not limited to user experience, typically including ease of navigation and encouragement of upgrades; internal member email that is secured real time delivery with spam protection; video/text chat with full bandwidth with voice and picture in real time; telephone voice mail/call forward without having to give out a real telephone number; cell phone dating with SMS, WAP and MMS; offline venues for safe haven to meet, mix and mingle; multiple membership levels; generic customer service; multiple payment options; advertising engine implementation; global payment options and affiliate/sub-affiliate/MLM programs.

It is contemplated that the subsets of criteria that a user forms to create have access to a shared database can be accessible to a plurality of devices, similar to as described above. These devices can include, but are not limited to a web browser, a mobile device, a PDA, an IPOD, PSP, a PS2, a cellular phone, a storage device, a mobile device, a prepaid device and a mechanical device. In a typical example, a user may want to access the information via a cellular phone. In such an example, the user may want to travel from his/her home state to another state. As such, the criteria can be set and locating systems such as GPS or triangulation systems can be employed to sense the cell phone and immediately apply the criteria to the new geographic location, thereby providing immediate access to other users in the area.

In the embodiments described above, payment options of the members are necessary to access the provided portals. In addition, a specific embodiment described the use of the web portals for online dating services. In a specific embodiment, a prepaid dating card can be used to provide membership payment. Embodiments of the prepaid dating card systems and methods are now described.

In general, embodiments of a prepaid dating card system and method allow a user to buy prepaid blocks of memberships, searches and other tools within online dating services. The systems and methods thereby allow a user to anonymously purchase prepaid funds on a card and subsequently use those funds for a series of online dating options. In a typical embodiment, a stored-value card is distributed to a merchant for distribution to a customer who has an account with a specific provider of goods and/or services. The stored value card has an associated identifier that can be used to associate a stored value with the card. The associated stored value is redeemable with one or more providers, including the specific provider. The account has an associated account number. During a card purchase transaction, a central processor receives a request to activate the card from a merchant terminal. The central processor receives a redemption request from the customer, wherein the redemption request includes the identifier. The central processor identifies the provider and the account number. The central processor inserts the associated value into the account for instance by passing a value insertion request to the provider. The central processor receives a subsequent request to activate the card from a different merchant terminal. The central processor recognizes the card, identifies the provider and account number, and automatically inserts the value into the account.

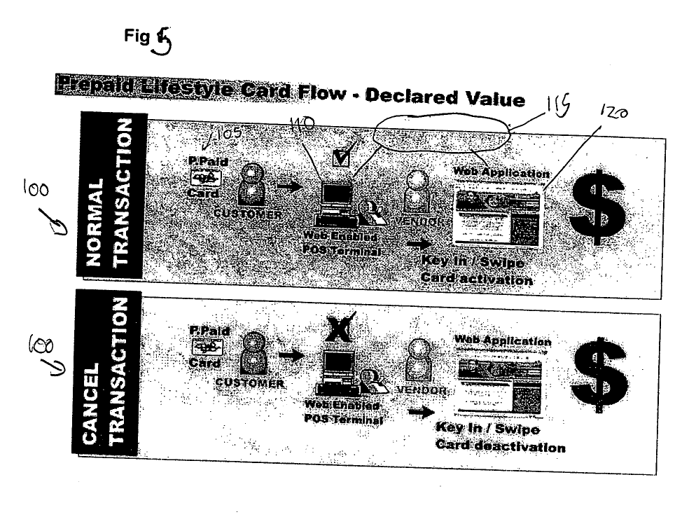

FIG. 5 illustrates an embodiment of a prepaid dating system 100 for a user to purchase and activate prepaid dating cards. In general, the system 100 includes a prepaid dating card 105 for interacting with a merchant terminal 110 for activation and value insertion of funds for later redeemable use for dating services, typically online dating services on a network 115. The merchant terminal 110 can typically be a point of sale (POS) terminal that is connected to the network 115, such as the Internet. In a typical implementation, the dating services are provided by a service provider having a presence on the network 115, such as through a web application 120. Typically, as described further below, the prepaid dating card 105 is activated (or deactivated) by conventional key-in or swipe methods.

Therefore, in a typical embodiment, various pre-existing and proven technologies can be used to empower the prepaid cards 105. For example, the prepaid dating card 105 can include a magnetic strip as a readable medium including the value insertion data. A standard card with data encoded in the IS08583 (1987) format readable by any POS system, such as the merchant terminal 115, can be implemented. In another embodiment, a unique buyer identification number (BIN) such as a “6” series BIN can be used for identification purposes. In general, the system 100 can include an activation and tracking interface that can be a proprietary web application on network 115 having several actions including but not limited to: activation, thereby making the prepaid dating card 105 active; cancellation, thereby canceling the activation of the prepaid dating card 105; returning unused prepaid cards 105, thereby refunding any balances of prior value insertion if the prepaid dating card 105 is unused; and redemption, which provides automatic value reduction of the prepaid dating card 105 as services are rendered.

In an initial process flow of the system 100, for example, for fixed value prepaid dating cards 105 that come in pre-selected denominations, a proven existing model, such as the model for prepaid phone card, can be advantageously implemented. In a typical embodiment, the prepaid dating card 105 is manufactured and packaged in a disabled, non-activated state. The prepaid card can include one or more form factors for a readable medium having data, such as magnetic strips, bar codes, numeric codes and the like. The prepaid card can be displayed at a retailer and selected by a customer. When the prepaid dating card 105 is scanned or swiped or other wise interacted to access and activate the readable medium, the prepaid dating card 105 is activated. Alternatively, the retailer or merchant can enter the card number or other unique code into a web portal to access the network 115. Alternatively, any other suitable channel can be implemented for activation. In another implementation, when the prepaid data card 105 is activated by UPC scanning, the receipt that is generated can include an activation code that can be subsequently manually entered by the user. The process can include individual store maximums that can be set to avoid theft of activated prepaid cards 195, and the prepaid cards 105 can typically be only activated by employees of the particular retailer location. This control feature allows limitation of the exposure and liability of individual shop owners. The consumer can then use the card based on T & C. In the event of a cancellation of the transaction, the prepaid dating card 105 can be re-swiped, or otherwise deactivated, the disable it again.

In general, network processing is implemented by tying into existing prepaid infrastructures for transaction processing. In other implementations, non-transferable, non-currency value attached to the prepaid dating card 105 such as months of dating site membership can be the value that is inserted into the prepaid dating card 105. In one implementation, debiting works as whole number transactions data associating how much value is left on the prepaid dating card 105 is centralized in a local network. Typically, authorizations come from back ends of the local network and are evidenced by the unique BIN. In a web application option, an interface is provided allowing store locations without the proper connections to still sell the prepaid dating cards 105 by using the web interface for activation.

The system 100 and users of the system 100 typically implement any number of redemptions models that can be of general or typical use. A user at any time can go to the network 115 or use phone chat lines (interactive voice response (IVR)/multimedia messaging system (MMS)/wireless application protocol (WAP)/short message service (SMS) and the like) and be served a payment prompt. At that time, the user typically elects the prepaid dating card 105 option. At that time, the card number is entered, followed by entering an X digit personal identification number (PIN). Typically, a form is populated and submitted for membership. At any time, the prepaid dating card 105 holder can use the IVR number on the back of the prepaid dating card 105 with using the PIN for access to included minutes for web, phone, mobile or any other dating service. Any combination of redemption changes the status on the prepaid dating card 105 invalidating it for any refund at the POS. Therefore, the prepaid dating card 105 provides any number of form factors for redemption including, but not limited to chat time, network access to any number of online dating portals, phone minutes and the like. In a typical embodiment, there are three desirable channels of use. 1) The Internet, in which a user logs onto a particular site, chooses a prepaid dating card 105 option, enters an X-variable digit number for log on. In one implementation, the prepaid dating card can include an IP address identifier that helps determine geographic location such that users will be geographically close to other users in case the users actually want to meet and interact. 2) Chat/Text messaging that provides access to text members, a short call number can be entered, then an access code. By using triangulation or global positioning system (GPS), proximate other users can be located. The triangulation or GPS allows suitable text and phone members to be brought together via this form factor. Furthermore, call Ids can be seamless implemented to allow proper geographical locations. 3) Interactive Voice Response (IVR) can be implemented by simply entering the IVR number and performing a reverse look up for suitable users. In general, the channels as described can allow identification by geographic region to find appropriate local chat rooms, thereby forming appropriate prepaid dating networks.

It is generally appreciated that specific embodiments of the systems and methods above have applicable age restrictions.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A method of providing a website on a network so that users seeking common interests can access one another on the network, the method comprising:
creating on the network a web portal;
granting web portal access to the users on the network;
providing to the users access to a components database connected to the network;
providing to the users a shared database connected to the network, the shared database based on criteria subsets chosen from the components database; and
providing a medium connected to the network through which a subset of users that match the criteria subsets can access so that the subset of users who share common interests can interact via the medium.

2. The method as claimed in claim 1 wherein the web portal is created using a pre-selected templates database.

3. The method as claimed in claim 1 wherein the web portal is created using proprietary templates.

4. The method as claimed in claim 1 wherein the web portal is developed using a modular site design system.

5. The method as claimed in claim 4 wherein the modular site-design system comprises:
a plurality of design modules;
an interface for selecting a subset of design modules of the plurality of design modules to be included in an electronic presence, the selected design modules forming a package of design modules; and
means for forwarding the package of design modules to an application service provider platform and deployment onto an electronic medium.

6. The method as claimed in claim 1 further comprising:
selecting design criteria; and
forwarding the design criteria which reside on an application service provider platform for electronic publishing.

7. The method as claimed in claim 6 wherein selecting design criteria comprises:
selecting a design module for the web portal;
selecting database inclusions for the web portal;
selecting database filters for the web portal; and
optionally selected inclusions of various product service offerings from a plurality of design modules at a graphic user interface.

8. The method as claimed in claim 1 wherein the web portal in one of a superset of modular web portals, thereby forming an electronic presence.

9. The method as claimed in claim 8 wherein the modular web portals are linked.

10. The method as claimed in claim 9 further comprising optionally updating one of the web portals.

11. The method as claimed in 10 wherein updating one of the web portals comprises:
forwarding an updated version of one of the modules to an application service provider using the one of the modules;
storing, at the application service provider, the updated version of the one of the modules; and
replacing, in a directory structure at the application service provider, a first pointer to an existing version of the one of the modules with a second pointer to the updated version of the one of the modules.

12. A network-based method, comprising:
providing a member database having data related to individual users, the users being members of a plurality of network websites;
providing a component database having pre-selected data components;
providing access for a member to choose a subset of the pre-selected data components to form a filter that selects a subset of data related to individual users from the first database; and
forming a second data base being populated with the subset of data that has been selected based on the subset of pre-selected data components of the component data base.

13. The method as claimed in claim 12 further comprising providing on-line communication access between members who share common interests identified by common selections of the component database.

14. The method as claimed in claim 13 wherein the communication access is a chatroom.

15. A method of network-based development of virtual communities, comprising:
accessing a network portal through a membership that provides access to the portal, the membership related to an interest;
using a graphical user interface having a series of fields into which data can be entered, the data relating to specific criteria subsets related to the interest;
submitting the data to the network, that data being used for a filter;
receiving return data to the graphical user interface from a shared database, wherein data in the shared interface has been received through the filter from a membership database populated with users who share membership access to the network portal; and
using the return data to access a subset of users based on the filter criteria, thereby forming a virtual community of users who share common interests, the subset of users being formed from filtering a larger community of users in the membership database.

16. The method as claimed in claim 15 further comprising an additional web portal connected to the network, the additional web portal providing access to the network and to the membership database, the additional web portal having fields that can be populated with criteria data to generate a filter that provides users of shared interests from the membership database.

17. The method as claimed in 15 further comprising rendering payment for membership with a prepaid dating card.
